(19) United States
(12) Patent Application Publication
(10) Pub. No.: US 2023/0395791 A1
(43) Pub. Date: Dec. 7, 2023

(54) CATHODE FOR ALL-SOLID-STATE BATTERIES AND METHOD FOR MANUFACTURING THE SAME

(71) Applicants: HYUNDAI MOTOR COMPANY, Seoul (KR); KIA CORPORATION, Seoul (KR)

(72) Inventors: Chung Bum Lim, Suwon-si (KR); Sang Heon Lee, Yongin-si (KR); Sung Woo Noh, Seoul (KR); Jeong Hyun Seo, Daejeon (KR); Im Sul Seo, Jincheon-gun (KR); Ju Yeong Seong, Seongnam-si (KR); Je Sik Park, Seoul (KR)

(73) Assignees: HYUNDAI MOTOR COMPANY, Seoul (KR); KIA CORPORATION, Seoul (KR)

(21) Appl. No.: 17/994,947

(22) Filed: Nov. 28, 2022

(30) Foreign Application Priority Data
Jun. 3, 2022 (KR) 10-2022-0068132

(51) Int. Cl. H01M 4/485; H01M 4/04; H01M 10/052

(52) U.S. Cl. CPC H01M 4/485; H01M 2004/028; H01M 10/052; H01M 4/0471

(57) ABSTRACT

A cathode for all-solid-state batteries includes an additive as a sacrificial cathode material, and a method for manufacturing cathode for all-solid-state batteries. The additive may include a compound represented by Formula 1 below,

(La_{2/3-x}Li₃ₓ□_{1/3-2x})TiO₃, [Formula 1]

wherein □ may indicate a vacant site for achieving charge neutrality depending on a doping amount of lithium, and x may satisfy an equation of 0.04≤x≤⅙.

### CROSS-REFERENCE TO RELATED APPLICATION

The present application claims priority to Korean Patent Application No. 10-2022-0068132 filed on Jun. 3, 2022, the entire contents of which is incorporated herein for all purposes by this reference.

### BACKGROUND OF THE PRESENT DISCLOSURE

### Field of the Present Disclosure

The present disclosure relates to a cathode for all-solid-state batteries which includes an additive as a sacrificial cathode material, and a method for manufacturing the cathode for all-solid-state batteries.

### Description of Related Art

A secondary battery which is rechargeable is used not only in small-sized electronic equipment, such as a mobile phone, a notebook, etc., but also in large-size transportation modes, such as a hybrid vehicle, an electric vehicle, etc. Therefore, development of secondary batteries having high stability and energy density is required now.

Most conventional secondary batteries include organic solvent (organic liquid electrolyte)-based cells, and have limits on improvement in stability and energy density.

On the other hand, an all-solid-state battery using an inorganic solid electrolyte is manufactured based on technology in which any organic solvent is excluded, and may thus include cells manufactured in a safe and simple form, thereby being spotlighted now.

The all-solid-state battery may include a sacrificial cathode material in order to conserve lithium ions consumed at the initial charging and discharging stage. The sacrificial cathode material is used in redox reactions at a potential lower than the discharge voltage of a cathode active material in the initial charging stage, and emits lithium ions. The redox reactions of the sacrificial cathode material occur at the potential lower than the discharge voltage of the cathode active material, and do not hinder charging and discharging reactions of the cathode active material during charging and discharging of the all-solid-state battery after the second cycle.

The information disclosed in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a cathode for all-solid-state batteries including an additive as a sacrificial cathode material, and a method for manufacturing the cathode for all-solid-state batteries.

In one aspect, the present disclosure may provide a cathode for all-solid-state batteries including a cathode active material, a solid electrolyte, and an additive represented by Formula 1 below,

(La_{2/3-x}Li₃ₓ□_{1/3-2x})TiO₃, [Formula 1]

wherein □ may indicate a vacant site for achieving charge neutrality depending on a doping amount of lithium, and x may satisfy an equation of 0.04≤x≤⅙.

In an exemplary embodiment of the present disclosure, the additive may have a perovskite crystal structure.

In another exemplary embodiment of the present disclosure, lithium atoms may be inserted into the vacant site □ of the additive.

In yet another exemplary embodiment of the present disclosure, the additive may have lithium ion conductivity of equal to or greater than about 1×10⁻³ S/cm, and electron conductivity of about 1×10⁻⁸S/cm to 1×10⁻²S/cm.

In yet another exemplary embodiment of the present disclosure, the additive may be formed in a pellet type.

In another aspect, the present disclosure may provide a method for manufacturing an all-solid-state battery, including preparing a starting material including a lanthanum compound, a titanium compound and a lithium compound, primarily calcining the starting material, secondarily calcining a resultant product obtained from the primary calcining at a temperature higher than a temperature of the primary calcining, preparing an additive represented by Formula 1 below by tertiarily calcining a resultant product obtained from the secondary calcining at a temperature higher than a temperature of the secondary calcining, and manufacturing the cathode including a cathode active material, a solid electrolyte and the additive,

(La_{2/3-x}Li₃ₓ□_{1/3-2x})TiO₃, [Formula 1]

wherein □ may indicate a vacant site for achieving charge neutrality depending on a doping amount of lithium, and x may satisfy an equation of 0.04≤x≤⅙.

In an exemplary embodiment of the present disclosure, the primary calcining may be performed at a temperature of about 500° C. to 800° C. for about 1 hour to 24 hours.

In another exemplary embodiment of the present disclosure, the secondary calcining may be performed at a temperature of about 1,000° C. to 1,300° C. for about 1 hour to 24 hours.

In yet another exemplary embodiment of the present disclosure, the secondary calcining may be repeated at least twice.

In yet another exemplary embodiment of the present disclosure, after the resultant product obtained from the secondary calcining is pelletized, the pelletized resultant product may be tertiarily calcined.

In still yet another exemplary embodiment of the present disclosure, the tertiary calcining may be performed at a temperature of about 1,350° C. to 1,500° C. for about 1 hour to 24 hours.

Other aspects and exemplary embodiments of the present disclosure are discussed infra.

The above and other features of the present disclosure are discussed infra.

### BRIEF DESCRIPTION OF THE DRAWINGS

FIG. 1 shows a cross-sectional view of an all-solid-state battery according to an exemplary embodiment of the present disclosure;

FIG. 2A shows the surface of an additive according to Manufacturing Example 1;

FIG. 2B shows the surface of an additive according to Manufacturing Example 2; and

FIG. 3 shows X-ray diffraction (XRD) result of the additive according to Manufacturing Example 1 in respective manufacturing operations.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present invention throughout the several figures of the drawings.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments, it will be understood that the present description is not intended to limit the present disclosure(s) to those exemplary embodiments. On the contrary, the present disclosure(s) is/are intended to cover not only the exemplary embodiments, but also various alternatives, modifications, equivalents and other embodiments, which may be included within the spirit and scope of the present disclosure as defined by the appended claims.

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present invention to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the present disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Furthermore, if such a range refers to integers, the range includes all integers from a minimum integer to a maximum integer, unless stated otherwise.

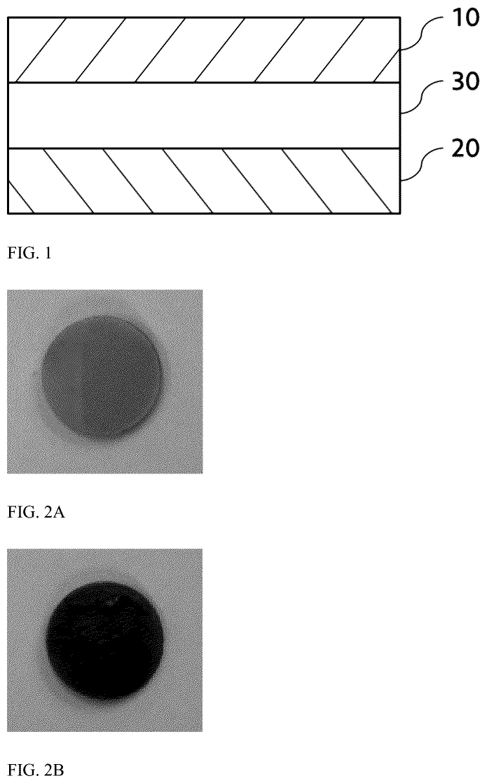

FIG. 1 shows a cross-sectional view of an all-solid-state battery according to an exemplary embodiment of the present disclosure. The all-solid-state battery may include a cathode 10, an anode 20, and a solid electrolyte layer 30 interposed between the cathode 10 and the anode 20.

The cathode 10 may include a cathode active material, a solid electrolyte, and an additive serving as a sacrificial cathode material.

The cathode active material may intercalate and deintercalate lithium ions. The cathode active material may include, for example, an oxide active material and a sulfide active material, without being limited to a specific material.

The oxide active material may include a rock salt layer-type active material, such as LiCoO₂, LiMnO₂, LiNiO₂, LiVO₂ or Liᵢ₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li_{1-x-y}Mn_{2-x-y}M_{y}O₄ (M being at least one of Al, Mg, Co, Fe, Ni or Zn, and 0<x+y<2), or lithium titanate, such as Li₄Ti₅O₁₂.

The sulfide active material may include copper Chevrel, iron sulfide, cobalt sulfide, nickel sulfide or the like.

The solid electrolyte may conduct lithium ions within the cathode 10. The solid electrolyte may include an oxide-based solid electrolyte or a sulfide-based solid electrolyte. Preferably, a sulfide-based solid electrolyte having high lithium ion conductivity may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

The additive may emit lithium ions during initial charging and discharging of the all-solid-state battery so as to compensate for the irreversible capacity of lithium ions generated in the anode 20, i.e., serve as a sacrificial cathode material.

The additive may include a compound represented by Formula 1 below.

(La_{2/3-x}Li₃ₓ□_{1/3-2x})TiO₃, [Formula 1]

Here, □ may indicate a vacant site for achieving charge neutrality depending on the doping amount of lithium, and x may satisfy an equation of 0.04≤x≤⅙. When x deviates from the above numerical range, the additive corresponds to a compound having a general perovskite crystal structure, and structural distortion does not occur, and thus, no pores may be formed. That is, even though the additive comes into contact with lithium metal, lithium ions do not migrate, and thus, electron conductivity may not be improved.

The additive may have a perovskite crystal structure. Lithium lanthanum titanate having the perovskite crystal structure, as set forth in Formula 1 has high lithium ion conductivity at room temperature, and thus does not hinger migration of lithium ions within the cathode 10.

The additive may have lithium ion conductivity of equal to or greater than about 1×10⁻³ S/cm. The upper limit of the lithium ion conductivity of the additive is not limited to a specific value, and may be equal to or less than, for example, about 1 S/cm, about 0.5 S/cm, or about 0.1 S/cm.

The additive may be configured such that a lithium atom is inserted into the vacant site □. Insertion of lithium atom into the vacant site □ may mean that the additive comes into physical contact and reacts with lithium metal so that lithium ions in lithium metal occupy the vacant site □, without changing the crystal structure of the additive.

As the lithium atom is inserted into the vacant site □ in the additive, Ti⁴⁺ ions are reduced to Ti³⁺ ions in the additive, and electronic conductivity of the additive is greatly increased. That is, the additive may serve as a conductive material in addition to as the sacrificial cathode material. Therefore, no conductive material may be added to the cathode 10, thereby being capable of solving problems, such as deterioration in performance due to side reactions between the conductive material and the solid electrolyte.

The electronic conductivity of the additive may be about 1×10⁻⁸ S/cm to 1×10⁻² S/cm.

When the lithium ion conductivity and the electronic conductivity of the additive belongs to the above-described numerical ranges, respectively, lithium ions and electrons may smoothly migrate within the cathode 10.

According to a first exemplary embodiments of the present invention, the anode 20 may be a composite anode including an anode active material and a solid electrolyte.

The anode active material may include, for example, a carbon active material or a metal active material, without being limited to a specific material.

The carbon active material may include mesocarbon microbeads (MCMB), graphite, such as highly oriented pyrolytic graphite (HOPG), or amorphous carbon, such as hard carbon or soft carbon.

The metal active material may include In, Al, Si, Sn, or an alloy including at least one of these elements.

The solid electrolyte may conduct lithium ions within the anode 20. The solid electrolyte may include an oxide-based solid electrolyte or a sulfide-based solid electrolyte. Preferably, a sulfide-based solid electrolyte having high lithium ion conductivity may be used as the solid electrolyte.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

According to a second exemplary embodiments of the present invention, the anode 20 may include lithium metal or a lithium metal alloy.

The lithium metal alloy may include an alloy of lithium and a metal or a metalloid capable of alloying with lithium. The metal or the metalloid capable of alloying with lithium may include Si, Sn, Al, Ge, Pb, Bi, Sb or the like.

According to a third exemplary embodiments of the present invention, the anode may not include any anode active material and any element which performs substantially the same function as the anode active material. Lithium ions migrating from the cathode 10 may precipitate in the form of lithium metal between the anode 20 and an anode current collector (not shown), and be stored, when the all-solid-state battery is charged.

The anode 20 may include amorphous carbon and a metal capable of alloying with lithium.

The amorphous carbon may include at least one selected from the group consisting of furnace black, acetylene black, Ketj en black, graphene and combinations thereof.

The metal capable of alloying with lithium may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

The solid electrolyte layer 30 may conduct lithium ions between the cathode 10 and the anode 20.

The solid electrolyte layer 30 may include a solid electrolyte. The solid electrolyte may include an oxide-based solid electrolyte or a sulfide-based solid electrolyte. Preferably, a sulfide-based solid electrolyte having high lithium ion conductivity may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—Li₁₀MO_{y} (x and y being positive numbers, and M being one of P, Si, Ge, B, Al, Ga and In), or Li₁₀GeP₂S₁₂.

A method for manufacturing a cathode for all-solid-state batteries according to the present disclosure may include preparing a starting material including a lanthanum compound, a titanium compound and a lithium compound, primarily calcining the starting material, secondarily calcining a resultant product acquired through the primary calcining at a temperature higher than a temperature of the primary calcining, preparing an additive represented by the above Formula 1 by tertiarily calcining a resultant product acquired through the secondary calcining at a temperature higher than a temperature of the secondary calcining, and manufacturing the cathode including a cathode active material, a solid electrolyte and the additive.

The lanthanum compound may include lanthanum oxide (La₂O₃). The titanium compound may include titanium oxide (TiO₂). The lithium compound may include lithium carbonate (LiCO₃). The starting material may be prepared by weighing the respective compounds depending on a desired composition of the additive, and mixing the respective compounds.

The starting material may be primarily calcined at a specific temperature. Carbon dioxide (CO₂) may be evaporated from lithium carbonate (LiCO₃) through the primary calcining.

The primary calcining may be performed under designated conditions, i.e., at a temperature of about 500° C. to 800° C. for about 1 hour to 24 hours. When the primary calcining is performed under the above conditions, lithium carbonate (LiCO₃) may be decomposed, and carbon dioxide (CO₂) may be discharged.

The resultant product acquired through the primary calcining may be secondarily calcined at the temperature higher than the temperature of the primary calcining. A perovskite crystal structure may be formed through the secondary calcining.

The secondary calcining may be performed under designated conditions, i.e., at a temperature of about 1,000° C. to 1,300° C. for about 1 hour to 24 hours. Furthermore, in order to increase a degree of crystallization, the secondary calcining may be repeated at least twice. When the secondary calcining is performed under the above conditions, the perovskite crystal structure may be formed.

Thereafter, the resultant product acquired through the secondary calcining may be pelletized. Pelletization is not limited to specific conditions, and pellets having a designated size may be formed by pressing the resultant product acquired through the secondary calcining at a pressure of about 100 MPa to 150 MPa. When the resultant product acquired through the secondary calcining is formed into the pellets, contact between the pellets is increased, and thus, removal of lithium through evaporation in high-temperature treatment may be prevented. The pellets may have a size of about 1 mm to 2 mm, without being limited to a specific size.

The resultant product acquired through the secondary calcining is tertiarily calcined at a temperature higher than the temperature of the secondary calcining. The additive represented by the above Formula 1 having the vacant site may be prepared through the tertiary calcining.

The tertiary calcining may be performed under designated conditions, i.e., at a temperature of about 1,350° C. to 1,500° C. for about 1 hour to 24 hours. When the tertiary calcining is performed under the above conditions, crystallinity of the additive may be increased.

The primary calcining, the secondary calcining and the tertiary calcining may be performed in air atmosphere.

A Lithium atom may be inserted into the vacant site of the additive by reacting the additive with lithium metal. After the additive and lithium metal come into contact with each other, the additive may react with lithium metal at room temperature or higher for about 10 minutes or longer under an inert or vacuum condition in which lithium metal is not oxidized. Lithium ions and electrons may smoothly migrate when such a reaction occurs at room temperature or higher. Furthermore, the additive may sufficiently react with lithium metal when the reaction occurs for about 10 minutes or longer.

The cathode may be manufactured by mixing the prepared additive with the cathode active material and the solid electrolyte. Manufacture of the cathode is not limited to a specific method, and the cathode may be acquired by a dry method in which the additive, the cathode active material and the solid electrolyte are mixed in a powder state and then pressed, or by a wet method in which a slurry including the additive, the cathode active material and the solid electrolyte is applied to a substrate and then dried, etc.

Hereinafter, the present disclosure will be described in more detail through the following examples. The following examples serve merely to exemplarily describe the present disclosure, and are not intended to limit the scope of the present disclosure.

### Manufacturing Example 1

An additive having the composition of (La_{0.55}Li_{0.36}□_{0.09})TiO₃ was prepared as follows.

A starting material in a powder state was acquired by weighing lanthanum oxide (La₂O₃), titanium oxide (TiO₂) and lithium carbonate (LiCO₃) based on the above composition and mixing the respective compounds.

The starting material was primarily calcined at a temperature of about 800° C. for about 2 hours.

A resultant product acquired through the primary calcining was secondarily calcined at a temperature of about 1,150° C. for about 12 hours, and thereafter, was secondarily calcined again at a temperature of about 1,150° C. for about 12 hours.

A resultant product acquired through the secondary calcining was formed into pellets, and then, the additive was prepared by tertiarily calcining the pellets at a temperature of about 1,350° C. for about 6 hours.

### Manufacturing Example 2

An additive, in which a lithium atom is inserted into the vacant site □ of the additive according to Manufacturing Example 1, was prepared by causing the additive according to Manufacturing Example 1 to come into contact with lithium metal and reacting the additive with lithium metal at room temperature or higher for about 10 minutes or longer under a vacuum condition.

FIG. 2A shows the surface of the additive according to Manufacturing Example 1. FIG. shows the surface of the additive according to Manufacturing Example 2. Referring to these figures, it may be confirmed that the color of the additive according to Manufacturing Example 2 was changed due to reduction of Ti⁴⁺ions to Ti³⁺ions through the reaction between lithium metal and the additive.

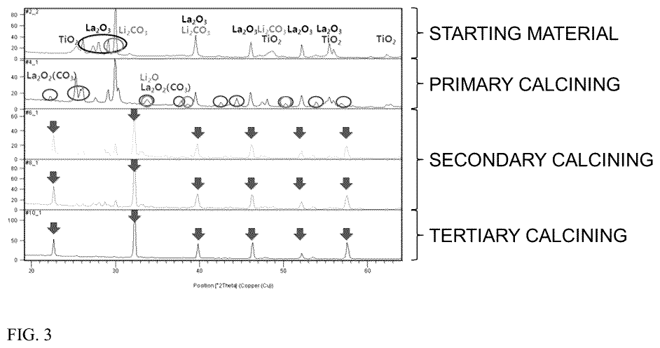

FIG. 3 shows X-ray diffraction (XRD) result of the additive according to Manufacturing Example 1 in respective manufacturing steps. Referring to this figure, it may be proved that the additive according to Manufacturing Example 1 has the composition of (La_{0.55}Li_{0.36}□_{0.09})TiO₃.

The lithium ion conductivities and the electronic conductivities of the additive according to Manufacturing Example 1 and the additive according to Manufacturing Example 2 were measured. Measurement results thereof are set forth in Table 1 below.

The lithium ion conductivities and the electron conductivities of the respective additives were measured under designated conditions, i.e., at a frequency of 20 MHz to 1 Hz and a pressure of 30 mV using Solartron 1260. Resistance values were acquired by inputting measured impedance results to an equivalent circuit (using Z-VIEW Software), and then, conductivity values were derived.

TABLE 1

| | Electronic conductivity | Lithium ion |
|---|---|---|
| Category | [S/cm] | conductivity [S/cm] |
| Manufacturing Example 1 | 1 × 10⁻⁸ | 1 × 10⁻³ |
| Manufacturing Example 2 | 1 × 10⁻² | 1 × 10⁻³ |

Referring to Table 1, it may be confirmed that electron conductivity of an additive may be greatly increased by injecting lithium atoms into the additive, like the additive according to Manufacturing Example 2.

### EXAMPLE 1

A cathode including the additive according to Manufacturing Example 1, a cathode active material and a solid electrolyte was manufactured. An all-solid-state battery having the structure shown in FIG. 1 was manufactured using the cathode.

### EXAMPLE 2

An all-solid-state battery was manufactured in the same manner as in Example 1, except that the additive according to Manufacturing Example 2 was used.

### Comparative Example 1

An all-solid-state battery was manufactured in the same manner as in Example 1, except that a carbon-based conductive material was used instead of the additive.

### Comparative Example 2

An all-solid-state battery was manufactured in the same manner as in Example 1, except that no additive was used.

The charge and discharge capacities and the efficiencies of the all-solid-state batteries according to Example 1, Example 2, Comparative Example 1 and Comparative Example 2 were measured. Results thereof are set forth in Table 2 below.

Here, the respective all-solid-state batteries were configured such that each of the all-solid-state batteries has a cathode active material layer including a sulfide-based solid electrolyte, a cathode active material and the corresponding additive at a ratio of 78.8:19.7:1.5, and the charge and discharge capacities of the respective all-solid-state batteries were measured under conditions of 3-4.25 V (in a CC-CV mode). The efficiency of each of the respective all-solid-state batteries was acquired by dividing the discharge capacity of the corresponding all-solid-state battery by the charge capacity of the corresponding all-solid-state battery.

TABLE 2

| | At C-rate of 0.1 C | | |
|---|---|---|---|
| | Charge capacity | Discharge capacity | |
| Category | [mAh/g] | [mAh/g] | Efficiency [%] |
| Example 1 | 103.6 | 76.4 | 73.7 |
| Example 2 | 214.2 | 187.0 | 87.3 |
| Comparative | 215.5 | 186.1 | 86.4 |
| Example 1 | | | |
| Comparative | 42.2 | 12.5 | 29.6 |
| Example 2 | | | |

Referring Table 2, it may be confirmed that the all-solid-state batteries according to Example 1 and Example 2, which include the additive according to an exemplary embodiment of the present disclosure, exhibited excellent charge and discharge capacities and efficiencies compared to the all-solid-state battery according to Comparative Example 2.

Furthermore, comparison in the measurement results between the all-solid-state batteries according to Example 2 and Comparative Example 1 represents that an all-solid-state battery exhibiting charging and discharge capacities and efficiency equivalent to those of an all-solid state battery using a conductive material may be manufactured using the additive according to an exemplary embodiment of the present disclosure without using any conductive material.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A cathode for all-solid-state batteries, the cathode comprising:
a cathode active material;
a solid electrolyte; and
an additive represented by Formula 1 below,
(La_{2/3-x}Li₃ₓ□_{1/3-2x})TiO₃, [Formula 1]
wherein □ indicates a vacant site for achieving charge neutrality depending on a doping amount of lithium, and 0.04≤x≤⅙.

2. The cathode of claim 1, wherein the additive has a perovskite crystal structure.

3. The cathode of claim 1, wherein a lithium atom is inserted into the vacant site □ of the additive.

4. The cathode of claim 1, wherein lithium ion conductivity of the additive is equal to or greater than about 1×10⁻³ S/cm.

5. The cathode of claim 1, wherein electronic conductivity of the additive is about 1×10⁻⁸ S/cm to 1×10⁻² S/cm.

6. The cathode of claim 1, wherein the additive is formed in a pellet type.

7. A method for manufacturing a cathode for all-solid-state batteries, the method comprising:
preparing a starting material comprising a lanthanum compound, a titanium compound and a lithium compound;
primarily calcining the starting material;
secondarily calcining a resultant product obtained from the primary calcining at a temperature higher than a temperature of the primary calcining;
preparing an additive represented by Formula 1 below by tertiarily calcining a resultant product obtained from the secondary calcining at a temperature higher than a temperature of the secondary calcining; and
manufacturing the cathode comprising a cathode active material, a solid electrolyte and the additive,
(La_{2/3-x}Li₃ₓ□_{1/3-2x})TiO₃, [Formula 1]
wherein □ indicates a vacant site for achieving charge neutrality depending on a doping amount of lithium, and 0.04≤x≤⅙.

8. The method of claim 7, wherein the primary calcining is performed at a temperature of about 500° C. to 800° C. for about 1 hour to 24 hours.

9. The method of claim 7, wherein the secondary calcining is performed at a temperature of about 1,000° C. to 1,300° C. for about 1 hour to 24 hours.

10. The method of claim 7, wherein the secondary calcining is repeated at least twice.

11. The method of claim 7, wherein, after the resultant product obtained from the secondary calcining is pelletized, the pelletized resultant product is tertiarily calcined.

12. The method of claim 11, wherein the pelletization is performed by pressing the resultant product acquired through the secondary calcining at a pressure of about 100 MPa to 150 MPa.

13. The method of claim 7, wherein the tertiary calcining is performed at a temperature of about 1,350° C. to 1,500° C. for about 1 hour to 24 hours.

14. The method of claim 7, wherein the additive has a perovskite crystal structure.

15. The method of claim 7, further comprising inserting a lithium atom into the vacant site □ of the additive by reacting the additive with lithium metal.

16. The method of claim 7, wherein lithium ion conductivity of the additive is equal to or greater than about 1×10⁻³ S/cm.

17. The method of claim 7, wherein electronic conductivity of the additive is about 1×10⁻⁸ S/cm to 1×10−2 S/cm.
